(19) United States
(12) Patent Application Publication
(10) Pub. No.: US 2015/0266151 A1
(43) Pub. Date: Sep. 24, 2015

(54) TOOL CHANGING METHOD FOR MACHINE TOOL

(71) Applicant: MITSUBISHI HEAVY INDUSTRIES, LTD., Tokyo (JP)

(72) Inventors: Yohei KOMATSU, Tokyo (JP); Keisuke YOSHIKAWA, Tokyo (JP)

(73) Assignee: MITSUBISHI HEAVY INDUSTRIES, LTD., Tokyo (JP)

(21) Appl. No.: 14/661,545

(22) Filed: Mar. 18, 2015

(30) Foreign Application Priority Data
Mar. 20, 2014 (JP) 2014-057545

(51) Int. Cl. B23Q 3/157; B23Q 3/155

(52) U.S. Cl. CPC B23Q 3/15713; B23Q 3/1554

(57) ABSTRACT

A tool changing method for a machining center configured to machine a workpiece with a long tool by three-dimensionally moving the long tool and the workpiece relative to each other, the long tool being detachably provided to a spindle, the workpiece being placed on a table with a pallet therebetween, the tool changing method including: transporting a pallet on which the long tool is placed, in such a way as to arrange the pallet on table of the machining center by using an automated guided vehicle configured to transport the pallet; and then three-dimensionally moving the pallet and the spindle relative to each to thereby attach the long tool to the spindle.

### TECHNICAL FIELD

The present invention relates to a tool changing method for attaching and detaching a long tool to and from the spindle of a machine tool such as a machining center for changing its tool.

### BACKGROUND ART

A machine tool such as a machining center is designed to be capable of automatically changing its tool on the spindle among various tools housed in a tool magazine by using a tool changing device. In a case where such a machine tool utilizes long tools (e.g. approximately 1000 mm) longer than generally used tools' lengths (around 500 mm), these long tools cannot be housed in the tool magazine. In view of this, a tool changing device has been proposed which, for example, is provided within a rack-type long-tool magazine configured to house long tools, and is configured to move the long-tool magazine to the vicinity of a spindle so that a desired long tool can be positioned in the vicinity of the spindle and the long tool can be attached to the spindle (see Patent Literature 1 listed below, for example).

### CITATION LIST

### Patent Literatures

### (Patent Literature 1) Japanese Patent Application Publication No. 2008-023661

(Patent Literature 2) Japanese Patent Application Publication No. Sho 60-197353

### SUMMARY OF INVENTION

### Technical Problems

However, since a tool changing device as mentioned above is configured to move the long tools together with the long-tool magazine, a driving device for moving the long-tool magazine is so large that the installation is difficult and also the cost increases.

### Solution to Problems

In view of the above, an object of the present invention is to provide a tool changing method for a machine tool capable of attaching and detaching a long tool to and from a spindle for changing its tool in a smaller space at a lower cost.

A tool changing method for a machining tool according to a first aspect of the invention for solving the above problems provides a tool changing method for a machine tool configured to machine a workpiece with a long tool by three-dimensionally moving the long tool and the workpiece relative to each other, the long tool being detachably provided to a spindle, the workpiece being placed on a table with a pallet therebetween, the too changing method including: transporting a pallet on which the long tool is placed, in which a way as to arrange the pallet onto the table of the machine tool by using an automated guided vehicle configured to transport the pallet and then three-dimensionally moving the pallet and the spindle relative to each other to thereby attach the long tool to the spindle.

Also, a tool changing method for a machine tool according to a second aspect of the invention provides the first aspect of the invention, further including: three-dimensionally moving the spindle to which the long tool is attached and the pallet relative to each other to thereby place the long tool from the spindle onto the pallet; and then transporting the pallet in such a way as to take the pallet off the table by using the automated guided vehicle.

Also, a tool changing method for a machine tool according to a third aspect of the invention provides the first aspect of the invention, in which the table of the machine tool includes automatic pallet changing means capable of detachably holding a plurality of the pallets side by side and moving the pallets between a machining position for machining the workpiece and a loading-unloading position for loading and unloading the pallets, and the method further comprises: arranging the pallet on which the long tool is placed, onto the table of the machine tool at the loading-unloading position by using the automated guided vehicle; moving the pallet in such a way as to position the pallet to the machining position by using the automatic pallet changing means and then three-dimensionally moving the pallet and the spindle relative to each other to thereby attach the long too to the spindle.

Also, a tool changing method for a machine tool according to a fourth aspect of the invention provides the first aspect of the invention, further including: three-dimensionally moving the spindle to which the long tool is attached and the pallet relative to each other to thereby place the long tool from the spindle onto the pallet positioned at the machining position; moving the pallet in such a way as to position the pallet to the loading-unloading position by using the automatic pallet changing means; and transporting the pallet positioned at the loading-unloading position in such a way as to take the pallet off the table by using the automated guided vehicle.

Also, a tool changing method for a machine tool according to a fifth aspect of the invention provides the first aspect of the invention, further including: arranging a long-tool supporting base configured to support the long tool onto the pallet; and placing the long tool onto the pallet with the long-tool supporting base therebetween.

### Advantageous Effects of Invention

According to the tool changing methods for a machine tool according to the present invention, attachment and detachment of a long tool to and from the spindle can be done without preparing a major driving device exclusively for changing the tool to or from the long tool. Thus, it is possible to attach and detach a long tool to and from the spindle of the machine tool for changing its tool in a smaller space at a lower cost.

### BRIEF DESCRIPTION OF DRAWINGS

FIG. 1 is an entire explanatory view of a main embodiment of a tool changing method for a machine tool according to the present invention;

FIG. 2 is an enlarged explanatory view of a chief part of FIG. 1; and

FIG. 3 is a side view of FIG. 2.

### DESCRIPTION OF EMBODIMENTS

A tool changing method for a machine tool according to the present invention will be described with reference to the drawings. However, the present invention is not limited only to the embodiment to be described below with reference to the drawings.

### Main Embodiment

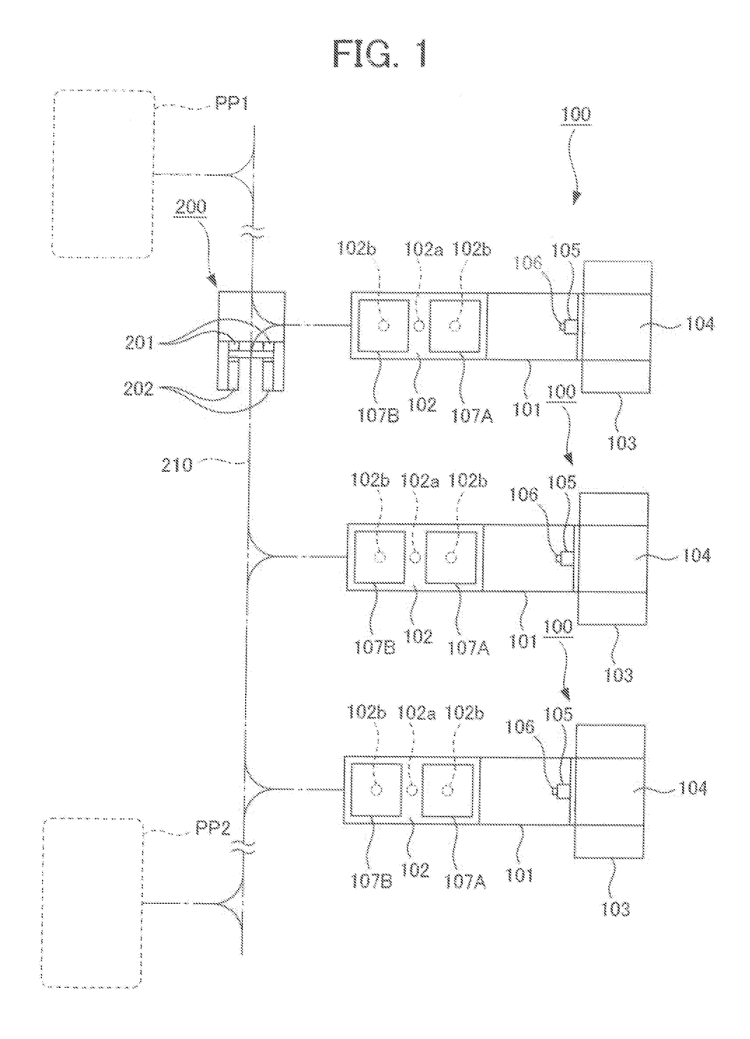

A main embodiment of the tool changing method for a machine tool according to the present invention will be described with reference to FIGS. 1 to 3.

As shown in FIG. 1, in a facility for machining a workpiece such as a cylinder block, for example, multiple (three in this embodiment) machining centers 100, which are machine tools, are arranged, and guide lines 210 for an automated guided vehicle (AGV) 200 are laid on the floor in such a way as to connect tables 102 of these machining centers 100 and pallet storing places PP1 and PP2 to each other and also connect the tables 102 of the machining centers 100 to each other. By using the automated guided vehicle 200, a workpiece can be transported to and arranged onto the table 102 of one machining center 100 together with a pallet stored in the pallet storing plate PP1; moreover, the workpiece machined on the table 102 of this machining center 100 can be transported to and transferred onto the table 102 of a different machining center 100 together with the pallet, and different machining can further be performed by the machining center 100; furthermore, the workpiece after the machining by these machining centers 100 can be transported to the pallet storing place PP2 together with the pallet and temporarily stored there.

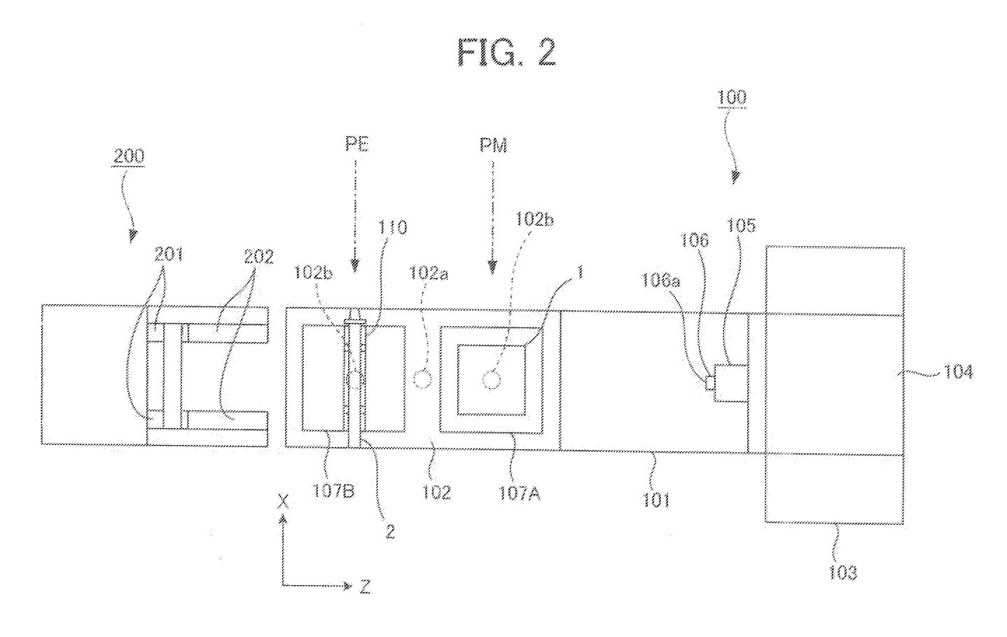

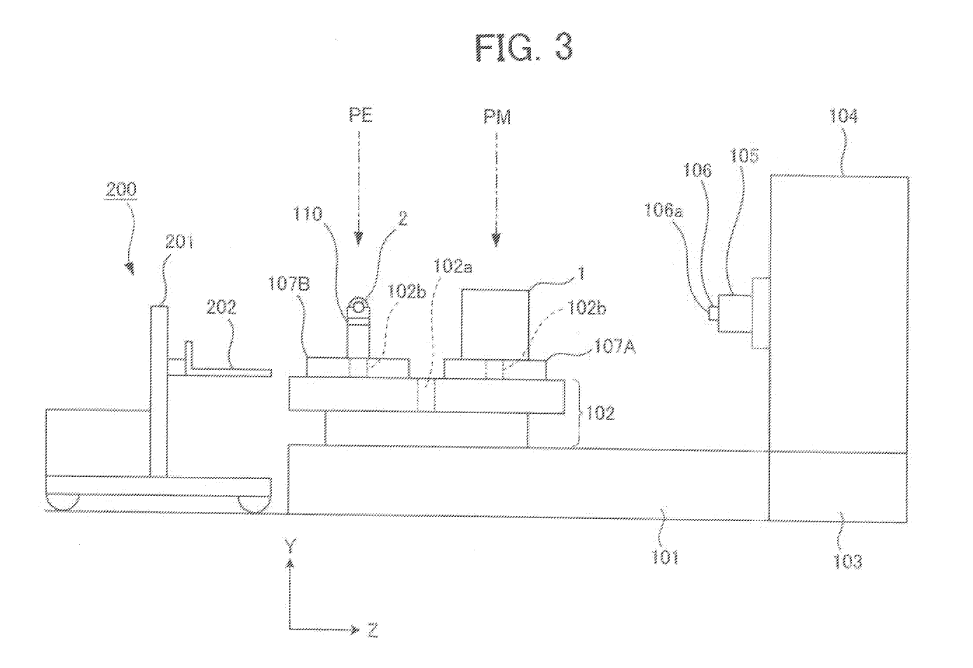

As shown in FIGS. 2 and 3, each machining center 100 is configured such that multiple pallets 107A and 107B can be arranged on the table 102 side by side. The table 102 is arranged on a bed 101 and is capable of moving (in the Z-axis direction) along the upper surface (guide surface) of the bed 101. In addition, an upper part of the table 102 is capable of turning (about the Y axis) at a horizontal plane through a turn shaft 102a. Thus, the pallets 107A and 107B can be moved between a machining position PM for machining a workpiece and a loading-unloading position PE for loading and unloading the pallets 107A and 107B.

Holding devices 102b configured to detachably hold the pallets 107A and 107B are provided in the upper part of the table 102 at positions which are symmetric with respect to the turn shaft 102a. The holding devices 102b are capable of turning (about the Y axis) the pallets 107A and 107B held thereon at the upper surface (guide surface) of the table 102. In this embodiment, each machining center 100 includes the table 102 which includes automatic pallet changing means formed by the turn shaft 102a, the holding devices 102b, and the like as described above.

Moreover, a column 104 is arranged on a bed 103. The column 104 is capable of moving (in the X-axis direction) along the upper surface (guide surface) of the bed 103. A spindle head 105 is attached to the front surface of the column 104. The spindle head 105 is capable of moving (in the Y-axis direction) along the front surface (guide surface) of the column 104. Note that in each of FIGS. 2 and 3, reference signs 106 and 106a denote a spindle and a spindle tip, respectively.

Each machining center 100 further includes a tool magazine configured to house tools to general lengths (around 500 mm) and a tool changing device (not shown) configured to change the tool at the spindle tip 106a of the spindle 106 to a desired tool in the tool magazine.

On the other hand, a fork 202 configured to support the pallets 107A and 107B is attached to a mast 201 of the automated guided vehicle 200 so as to be capable of being lifted and lowered (in the Y-axis direction in FIGS. 2 and 3). Moreover, the mast 201 of the automated guided vehicle 200 is provided so as to capable of moving in the direction of travel to make the fork 202 advance and retract (in the Z-axis direction in FIGS. 2 and 3).

Meanwhile, the pallet 107A on which a workpiece 1 is placed, and the pallet 107B on which a long-tool supporting base 110 configured to support a long tool 2 is placed are stored in the pallet storing places PP1 and PP2. The long-tool supporting base 100 has a positioning groove configured to support the long tool 2 at a predetermined position along a radial direction at a horizontal plane.

In the facility including the machining centers 100 and the automated guided vehicle 200 as described above, the workpiece 1 is machined as follows. First, in the pallet storing place PP1, the pallet 107A on which the workpiece 1 is placed is lifted with the fork 202 of the automated guided vehicle 200 and transported by the automated guided vehicle 200 along the guided lines 210 to the loading-unloading position PE on the table 102 of the target machining center 100 (e.g. the one at the top in FIG. 1). Then, the pallet 107A is placed onto the table 102 by lowering the fork 202 and held by one of the holding devices 102b. Further, the automated guided vehicle 200 is caused by move along the guide lines 210 to a retreat position.

Then, the upper part of the table 102 of the machining center 100 is turned about the turn shaft 102a such that the pallet 107A attached to the table 102 at the loading-unloading position PE can be positioned to the machining position PM. Also, a desired tool in the tool magazine is attached to the spindle 106 by the tool changing device. Thereafter, with the spindle 106 being rotated, the table 102 is moved in the Z-direction, the pallet 107A is turned about the Y axis by the holding device 102b, the column 104 is moved in the X-axis direction, and the spindle head 105 is moved in the Y-axis direction. As a result, the workpiece 1 on the pallet 107A and the tool are three-dimensionally moved relative to each other, thereby performing machining on the workpiece 1 with the tool of a general length.

In a case, for example, of performing machining with the long tool 2 after the machining with the tool of the general length as described above is finished, the tool at the spindle 106 of the machining center 100 is housed to the tool magazine by the tool changing device.

Then, in the pallet storing place PP1, the pallet 107B on which the long-tool supporting base 110 supporting the long tool 2 is placed is lifted with the fork 202 of the automated guided vehicle 200, and the pallet 107B is transported by the automated guided vehicle 200 along the guide lines 210 to the loading-unloading position PE on the table 102 of the machining center 100. Then, the pallet 107B is placed onto the table 102 by lowering the fork 202 and held by the other holding device 102b. Further, the automated guided vehicle 200 is caused to move along the guide lines 210 to the retreat position.

Then, the upper part of the table 102 of the machining center 100 is turned about the turn shaft 102a such that the pallet 107B attached to the table 102 at the loading-unloading position PE can be positioned to the machining position PM. By this operation, the pallet 107A which is positioned at the machining position PM and on which the workpiece 1 is placed is moved to be positioned to the loading-unloading position PE.

Thereafter, the holding device 102b holding the pallet 107B turns the pallet 107B, and also the column 104 and the spindle head 105 are moved such that the position of the axis of the spindle 106 and the position of the axis of the long tool 2 can coincide with each other in the X-axis direction and the Y-axis direction. Then, the table 102 is moved in the Z-axis direction toward the column 104. As a result, the table 102 and the spindle 106 are three-dimensionally moved relative to each other, thereby attaching the long tool 2 to the spindle tip 106a of the spindle 106.

Once the long tool 2 is attached to the spindle tip 106a of the spindle 106 as described above, the upper part of the table 102 is turned about the turn shaft 102a such that the pallet 107A on which the workpiece 1 is placed can be returned from the loading-unloading position PE to the machining position PM. By this operation, the pallet 107B which is positioned at the machining position PM and which now has nothing on the long-tool supporting base 110 is moved to be positioned to the loading-unloading position PE.

Then, with the spindle 106 rotated, the table 102 is moved in the Z-axis direction, the pallet 107A is turned about the Y axis by the holding device 102b, the column 104 is moved in the X-axis direction, and the spindle head 105 is moved in the Y-axis direction. As a result, the workpiece 1 and the long tool 2 are three-dimensionally moved relatively to each other, thereby performing machining on the workpiece 1 with the long tool 2.

Once the machining of the workpiece 1 with the long tool 2 as described above is finished, the upper part of the table 102 is turned about the turn shaft 102a such that the pallet 107B which is positioned at the loading-unloading position PE and has nothing on the long-tool supporting base 110 can be positioned again to the machining position PM. By this operation, the pallet 107A which is positioned at the machining position PM and on which the workpiece 1 is placed is moved to be positioned to the loading-unloading position PE.

Thereafter, the machining center 100 is operated in an order reverse to that of the operation described above, so that the long tool 2 attached to the spindle 106 is placed onto the long-tool supporting base 110 of the pallet 107B positioned at the machining position PM and the long tool 2 is detached from the spindle 106.

Then, in a case, for example, of further machining the workpiece 1 in the machining center 100 with the previous tool, the upper part of the table 102 is turned about the turn shaft 102a such that the pallet 107A which is positioned at the loading-unloading position PE and on which the workpiece 1 is placed can be returned again to the machining position PM. Also, the tool in the tool magazine is attached to the spindle 106 by the tool changing device. Thereafter, similar operation to that described above is performed. In this way, the workpiece 1 can be further machined with the tool of the general length.

Moreover, by the turn of the upper part of the table 102, the pallet 107B which is positioned at the machining position PM and has the long tool 2 placed on the long-tool supporting base 110 is moved to be positioned to the loading-unloading position PE. At the same time, the automated guided vehicle 200 is caused to move along the guide lines 210 to the loading-unloading position PE on the table 210 of the machining center 100, and the pallet 107B which is positioned at the loading-unloading position PE and has the long tool 2 placed on the long-tool supporting base 110 is lifted with the fork 202 of the automated guided vehicle 200 to be taken off the table 102. The automated guided vehicle 200 is then caused to move along the guide lines 210 to the pallet storing place PP1 and lower the fork 202 to return the pallet 107B to the pallet storing place PP1.

On the other hand, in a case, for example, of performing different machining with a different machining center 100 (e.g. the one in the middle in FIG. 1) after the machining of the workpiece 1 with the above machining center 100 is finished, the upper part of the table 102 is turned about the turn shaft 102a such that the pallet 107B which is positioned at the machining position PM and has the long tool 2 placed on the long-tool supporting base 110 can be positioned to the loading-unloading position PE. However, before this turn, the automated guided vehicle 200 is caused to move along the guide lines 210 to the loading-unloading position PE on the table 102 of the machining center 100, and the pallet 107A which is positioned at the loading-unloading position PE and on which the workpiece 1 is placed is lifted with the fork 202 of the automated guided vehicle 200 to be taken off the table 102. The table 102 is then turned.

Thereafter, the automated guided vehicle 200 is caused to move along the guide lines 210 to the loading-unloading position PE on the table 102 of the different machining center 100 (e.g. the one in the middle in FIG. 1) and lower the fork 202 to place the pallet 107A onto the table 102. The automated guided vehicle 200 is then is caused to return again to the previous machining center 100 (the one at the top in FIG. 1) along the guide lines 210.

Subsequently, the automated guided vehicle 200 is caused to lift the pallet 107B which is positioned at the loading-unloading position PE and has the long tool 2 placed on the long-tool supporting base 110 with the fork 202 to take it off the table 102. Then, the automated guided vehicle 200 is caused to move along the guide lines 210 to the pallet storing place PP1 and lower the fork 202 to return the pallet 107B to the pallet storing place PP1.

Note that once all the machining on the workpiece 1 by the machining centers is finished, the pallet 107A on which the workpiece 1 is placed is transported along the guide lines 210 to the pallet storing place PP2 and unloaded there by the automated guided vehicle 200.

In sum, in this embodiment, the long tool 2 is attached to and detached from the spindle 106 by: arranging the long tool 2 onto the table 102 of the machining center 100 with the long-tool supporting base 110 and the pallet 107B therebetween by using the automated guided vehicle 200 configured to transport the workpiece 1 onto the table 102 of the machining center 100; turning the table 102 and the pallet 107B; and three-dimensionally moving the table 102 and the spindle 106 relative to each other.

For this reason, in this embodiment, as long as the long-tool supporting base 110 is arranged on the pallet 107B, the attachment and detachment of the long tool 2 to and from the spindle 106 can be done without preparing a major driving device exclusively for changing the tool to or from the long tool 2, by using the automated guided vehicle 200 and also utilizing the automatic pallet changing means (APC) of the machining center 100.

Thus, according to this embodiment, it is possible to attach and detach the long tool 2 to and from the spindle 106 of the machining center 100 for changing its tool in a smaller space at a lower cost.

### Other Embodiments

Here, in the above embodiment, the long tool 2 is placed on the pallet 107B on the machining center 100 with the long-tool supporting base 110 therebetween. However, as another embodiment, the long tool 2 can be attached to and detached from the spindle tip 106a of the spindle 106 by, for example, not using the long-tool supporting base 110 but directly placing the long tool 2 on the pallet 107B and three-dimensionally moving the pallet 107B and table 102 and the spindle 106 relative to each other, depending upon the shapes, sizes, and the like of the long tool 2 and the pallet 107B.

Moreover, in the above embodiment, the changing method is described in which the long tool 2 is attached to and detached from the spindle 106 of the machining center 100 including the table 102 including the automatic pallet changing means which is formed of the turn shaft 102a, the holding devices 102b, and the like and on which the multiple pallets 107A and 107B can be arranged side by side. However, the present invention is not limited to this method. As another embodiment, a long tool can be attached to and detached from the spindle of a machine tool for changing the tool thereof as is done in the above embodiment, the machine tool being a machining center or the like that, for example, includes a table without the automatic pallet changing means, i.e. a turnable table including holding means on which only one pallet can be arranged and which detachably holds the pallet.

### INDUSTRIAL APPLICABILITY

The tool changing method for a machine tool according to the present invention is capable of attaching and detaching a long tool to and from the spindle of a machine tool for changing the tool thereof in a smaller space at a lower cost, and can therefore be used significantly beneficially in the industries of machining various materials including metals.

### REFERENCE SIGNS LIST

1 Workpiece
2 Long Tool
100 Machining Center
101 Bed
102 Table
102a Turn Shaft
102b Holding Table
103 Bed
104 Column
105 Spindle Head
106 Spindle
106a Spindle Tip
107A, 107B Pallet
110 Long-Tool Supporting Base
200 Automated Guided Vehicle (AGV)
201 Mast
202 Fork
210 Guide Line

1. A tool changing method for a machine tool configured to machine a workpiece with a long tool by three-dimensionally moving the long tool and the workpiece relative to each other, the long tool being detachably provided to a spindle, the workpiece being placed on a table with a pallet therebetween, the tool changing method comprising:
transporting a pallet on which the long tool is placed, in such a way as to arrange the pallet onto the table of the machine tool by using an automated guided vehicle configured to transport the pallet; and
then three-dimensionally moving the pallet and the spindle relative to each other to thereby attach the long tool to the spindle.

2. The tool changing method for a machine tool according to claim 1, further comprising:
three-dimensionally moving the spindle to which the long tool is attached and the pallet relative to each other to thereby place the long tool from the spindle onto the pallet; and
then transporting the pallet in such a way as to take the pallet off the table by using the automated guided vehicle.

3. The tool changing method for a machine tool according to claim 1, wherein
the table of the machine tool includes automatic pallet changing means capable of detachably holding a plurality of the pallets side by side and moving the pallets between a machining position for machining the workpiece and a loading-unloading position for loading and unloading the pallets, and
the method further comprises:
arranging the pallet on which the long tool is placed, onto the table of the machine tool at the loading-unloading position by using the automated guided vehicle;
moving the pallet in such a way as to position the pallet to the machining position by using the automatic pallet changing means; and
then three-dimensionally moving the pallet and the spindle relative to each other to thereby attach the long tool to the spindle.

4. The tool changing method for a machining tool according to claim 1, further comprising:
three-dimensionally moving the spindle to which the long tool is attached and the pallet relative to each other to thereby place the long tool from the spindle onto the pallet positioned at the machining position;
moving the pallet in such a way as to position the pallet to the loading-unloading position by using the automatic pallet changing means; and
transporting the pallet positioned at the loading-unloading position in such a way as to take the pallet off the table by using the automated guided vehicle.

5. The tool changing method for a machine tool according to claim 1, further comprising:
arranging a long-tool supporting base configured to support the long tool onto the pallet; and
placing the long tool onto the pallet with the long-tool supporting base therebetween.
